(19) United States
(12) Patent Application Publication
(10) Pub. No.: US 2003/0021347 A1
(43) Pub. Date: Jan. 30, 2003

(54) Reduced comlexity video decoding at full resolution using video embedded resizing

(75) Inventors: Tse-Hua Lan, Ossining, NY (US); Zhun Zhong, Croton-On-Hudson, NY (US)

Correspondence Address: Corporate Patent Counsel, Philips Electronics North America Corporation, 580 White Plains Road, Tarrytown, NY, 10591, US

(73) Assignee: Koninklijke Philips Electronics N.V.

(21) Appl. No.: 09/912,132

(22) Filed: Jul. 24, 2001

(51) Int. Cl. H04N 7/12

(52) U.S. Cl. 375/240.27; 375/240.12; 375/240.21; 375/240.2; 375/240.16

(57) ABSTRACT

The present invention is directed to decoding a video bitstream at a first resolution where embedded resizing is used in conjunction with external scaling in order to reduce the computational complexity of the decoding. According to the present invention, residual error frames are produced at a second lower resolution. Motion compensated frames are produced also at the second lower resolution. The residual error frames are then combined with the motion compensated frames to produce video frames. Further, the video frames are up-scaled to the first resolution.

### BACKGROUND OF THE INVENTION

The present invention relates generally to video compression, and more particularly, to decoding where embedded resizing is used in conjunction with external scaling in order to reduce the computational complexity of the decoding.

Video compression incorporating a discrete cosine transform (DCT) is a technology that has been adopted in multiple international standards such as MPEG-1, MPEG-2, MPEG-4, and H.262. Among these schemes, MPEG-2 is the most widely used, in DVD, satellite DTV broadcast, and the U.S. ATSC standard for digital television.

An example of a MPEG video decoder is shown in FIG. 1. The MPEG video decoder is a significant part of MPEG-based consumer video products. In such products, a desirable goal is to minimize the complexity of the decoder while maintaining the video quality.

### SUMMARY OF THE INVENTION

The present invention is directed to decoding a video bitstream at a first resolution where embedded resizing is used in conjunction with external scaling in order to reduce the computational complexity of the decoding. According to the present invention, residual error frames are produced at a second lower resolution. Motion compensated frames are produced also at the second lower resolution. The residual error frames are then combined with the motion compensated frames to produce video frames. Further, the video frames are up-scaled to the first resolution.

According to the present invention, the up-scaling may be performed by a technique selected from a group consisting of repeating pixel values and linear interpolation. Further, the up-scaling is performed in a same direction as down scaling in the residual error frames. In one example of the present invention, the up-scaling is performed in a horizontal direction.

### BRIEF DESCRIPTION OF THE DRAWINGS

Referring now to the drawings were like reference numbers represent corresponding parts throughout:

FIG. 1 is a block diagram of a MPEG decoder;

FIG. 2 is a block diagram of one example of a decoder according to the present invention;

FIG. 3 is a block diagram of another example of a decoder according to the present invention; and

FIG. 4 is a block diagram of one example of a system according to the present invention.

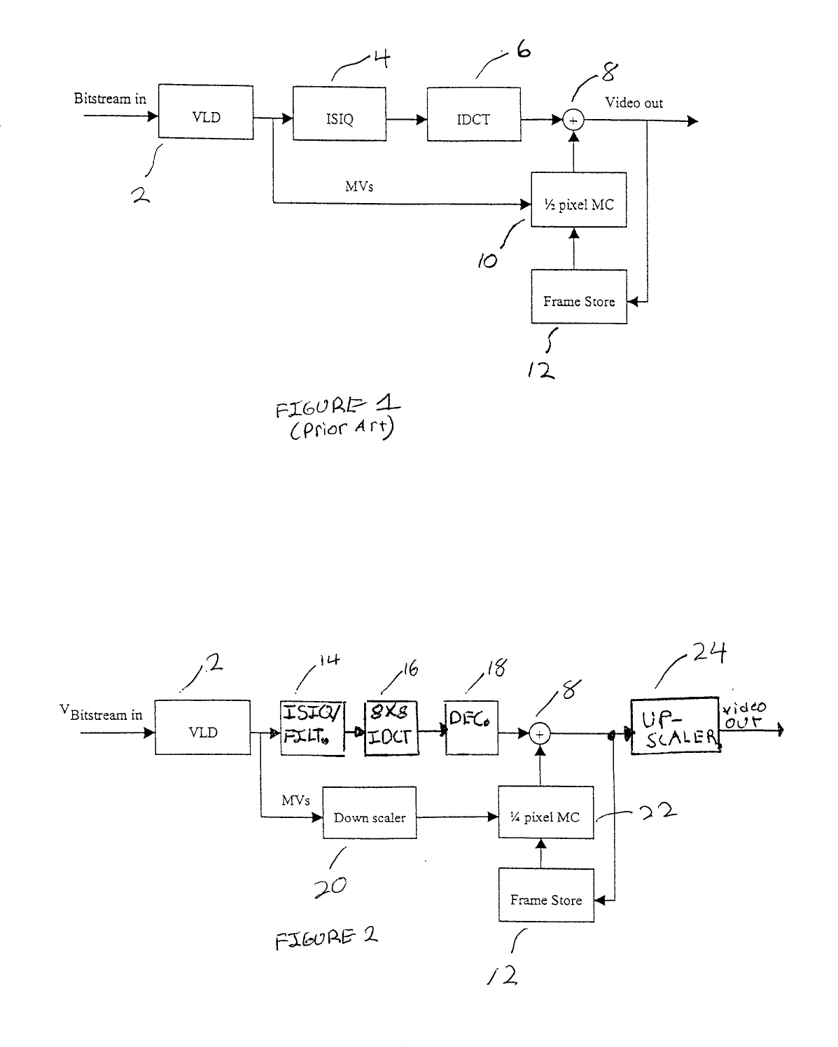

### DETAILED DESCRIPTION

The present invention is directed to decoding where embedded resizing is used in conjunction with external scaling in order to reduce the computational complexity of the decoding. According to the present, a video bitstream is decoded with a reduced output resolution using embedded resizing. The output video is then up scaled to the display resolution using external scaling. Since the embedded resizing may enable both the inverse discrete transform (IDCT) and motion compensation (MC) to be performed at a lower resolution, the overall computational complexity of the decoding is reduced.

One example of a decoder according to the present invention is shown in FIG. 2. As can be seen, the decoder includes a first path made up of the variable length decoder (VLD) 2, inverse scan and inverse quantization (ISIQ)/filtering block 14, 8×8 IDCT 16 and decimation block 18.

During operation, the VLD 2 will decode the incoming video bitstream to produce motion vectors (MV) and DCT coefficients. The ISIQ/filtering block 14 then inverse scans and inverse quantizes the DCT coefficients received from the VLD 2. In MPEG-2, inverse zig-zag scanning is performed. Further, the IDCT/filtering block 14 also performs filtering to eliminate high frequencies from the DCT coefficients.

In this embodiment, the 8×8 IDCT 16 performs an inverse discrete transform in 8×8 blocks to produce blocks of pixel values. After performing the IDCT, the decimation block 18 then samples the output of the 8×8 IDCT 16 at a predetermined rate in order to reduce the resolution of the video frames being decoded. According to the present invention, the decimation block 18 may sample the pixel values in the horizontal direction, vertical direction or both.

Further, the sampling rate of the decimation block 18 is chosen according to the desired level of internal scaling. In this embodiment, the sampling rate is “2” to provide an output resolution of “½” since a ¼ pixel MC unit is being utilized. However, according to the present invention, other sampling rates may be chosen to provide a different resolution such as “¼” or “⅛”. At the output of the decimation block 18, decoded I-frames and residual error frames are produced at a reduced resolution. As can be seen, these frames are provided at one side of an adder 8.

As can be further seen, the decoder also includes a second path made up of the VLD 2, a down scaler 20, a ¼ pixel MC 22 unit and a frame store 12. During operation, the down scaler 20 reduces the magnitude of the MVs provided by the VLD 2 proportional to the reduction in the first path. This will enable the motion compensation to be performed at a reduced resolution to match the frames produced in the first path. In this embodiment, the MVs are scaled down by a factor of “2” to match the sampling rate of the decimation unit 18.

The ¼ pixel MC unit 22 then performs motion compensation on pervious frames stored in the frame 12 store according to the scaled down MVs. In this embodiment, since the MVs have been scaled down by a factor of “2”, the motion compensation will be performed at a “¼” resolution. At the output of the ¼ pixel MC unit 22, motion compensated frames at a reduced resolution are produced. As can be seen, these frames are provided to the other side of the adder 8.

During operation, the adder 8 combines the frames from the first and second paths to produce video frames at a reduced resolution. As can be seen, the video frames from the adder 8 are then provided to an external up-scaler 24. The up-scaler 24 is external since it is placed outside the decoding loop. The up-scaler 8 increases the resolution of the video frames to the full display resolution. The increase in resolution is proportional to the decrease that occurred internal to the decoding loop. In this embodiment, the up-scaler 24 will increase the resolution of the video frames by a factor of “2”.

Further, the up-scaler 24 may also increase the resolution in the horizontal direction, vertical direction or both depending on the scaling done internally. For example, if the original resolution of the bitstream was “720×480” and it was reduced to “360×480” by the internal scaling, the up-scaler 24 would perform horizontal scaling from “360×480” to “720×480”.

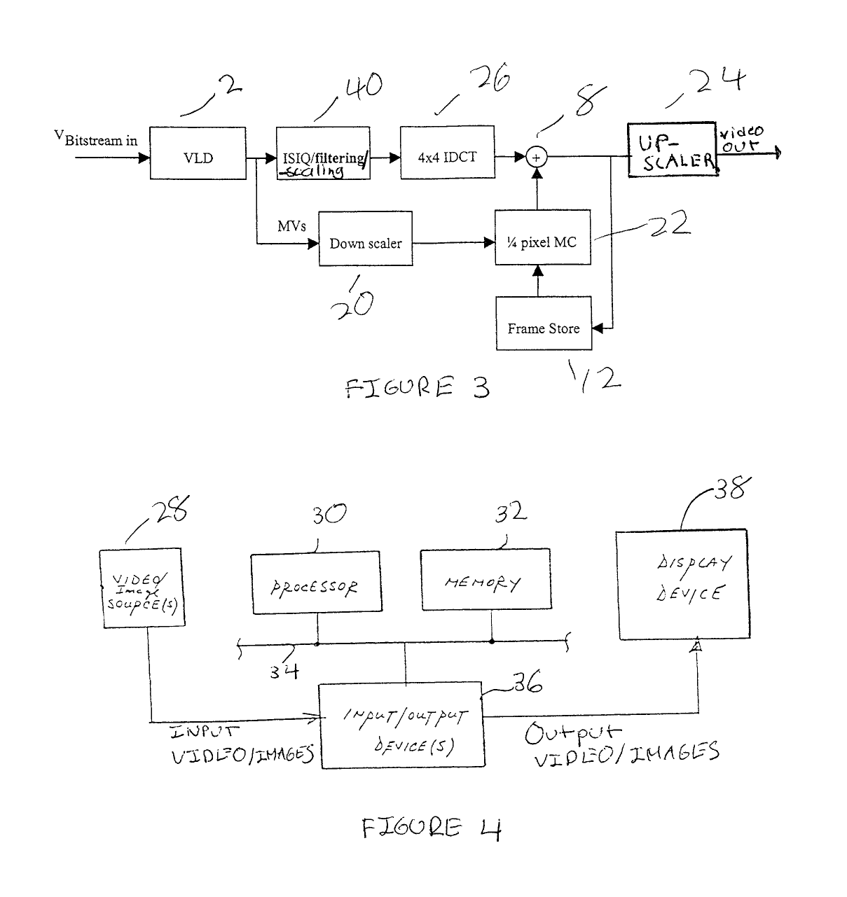

Another example of a decoder according to the present invention is shown in FIG. 3. The decoder of FIG. 3 is the same as FIG. 2 except for the first path. As can be seen, in this example, the first path includes a VLD 2, an ISIQ/filtering/scaling block 40 and a 4×4 IDCT block 26. Therefore, in this example, the IDCT is performed at the reduced resolution which further reduces the overall computational complexity of the decoding.

During operation, the ISIQ/filtering/scaling block 40 inverse scans and inverse quantizes the DCT coefficients received from the VLD 2. The IDCT/filtering/scaling block 40 also performs filtering to eliminate high frequencies from the DCT coefficients. However, in this example, IDCT/filtering/scaling block 40 also performs scaling on the DCT coefficients received from the VLD 2. In this example, the IDCT/filtering/scaling block 40 will down scale 8×8 DCT blocks received from the VLD 2 to 4×4 blocks.

The 4×4 IDCT 26 then performs an inverse discrete transform in 4×4 blocks to produce blocks of pixel values. The output of the 4×4 IDCT 26 is then provided to one input of the adder 8

As in the previous example, the adder 8 combines the frames from the first and second paths to produce video frames at a reduced resolution. As previously described, decoded I-frames and residual error frames are produced by the first path 2,40,26, while motion compensated frames are produced by the second path 12,20,22. The up-scaler 24 then increases the resolution of the video frames to the full display resolution. In this example, the up-scaler also increases the resolution by a factor of “2” in both the horizontal and vertical direction.

According to the present invention, the decoders of FIGS. 2-3 may be implemented in hardware, software or a combination of both. In a software implementation, it is preferred that the up-scaler 24 utilize a simple up-scaling technique such as just repeating pixel values or using a linear interpolation. In other embodiments, the up-scaler 24 may be implemented in hardware and thus a more complex technique may be used. For example, in the PHILIPS TRIMEDIA chip, a dedicated coprocessor is included for performing scaling. This coprocessor uses a programmable five-tap filter arrangement where additional pixel values are calculated based on a weighted average of five pixels. Therefore, the up-scaler 24 may be implemented using this dedicated processor while the rest of the decoder may be implemented in software and run on the CPU core of the PHILIPS TRIMEDIA processor.

One example of a system in which the decoding utilizing embedded resizing in conjunction with external scaling may be implemented is shown in FIG. 4. By way of example, the system may represent a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. The system includes one A or more video sources 28, one or more input/output devices 36, a processor 30, a memory 32 and a display device 38.

The video/image source(s) 28 may represent, e.g., a television receiver, a VCR or other video/image storage device. The source(s) 28 may alternatively represent one or more network connections for receiving video from a server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks.

The input/output devices 36, processor 30 and memory 32 communicate over a communication medium 34. The communication medium 34 may represent, e.g., a bus, a communication network, one or more internal connections of a circuit, circuit card or other device, as well as portions and combinations of these and other communication media. Input video data from the source(s) 28 is processed in accordance with one or more software programs stored in memory 32 and executed by processor 30 in order to generate output video/images supplied to the display device 38.

In one embodiment, the decoding utilizing embedded resizing in conjunction with external scaling is implemented by computer readable code executed by the system. The code may be stored in the memory 32 or read/downloaded from a memory medium such as a CD-ROM or floppy disk. In other embodiments, hardware circuitry may be used in place of, or in combination with, software instructions to implement the invention.

While the present invention has been described above in terms of specific examples, it is to be understood that the invention is not intended to be confined or limited to the examples disclosed herein. For example, the present invention has been described using the MPEG-2 framework. However, it should be noted that the concepts and methodology described herein is also applicable to any DCT/motion prediction schemes, and in a more general sense, any frame-based video compression schemes where picture types of different inter-dependencies are allowed. Therefore, the present invention is intended to cover various structures and modifications thereof included within the spirit and scope of the appended claims.

What is claimed is:

1. A method for decoding a video bitstream at a first resolution, comprising the steps of:
producing residual error frames at a second lower resolution;
producing motion compensated frames at the second lower resolution;
combining the residual error frames with the motion compensated frames to produce video frames; and
up-scaling the video frames to the first resolution.

2. The method of claim 1, wherein the producing residual error frames includes performing an 8×8 inverse discrete transform to produce pixel values.

3. The method of claim 2, wherein the pixel values are sampled at a predetermined rate.

4. The method of claim 1, wherein the producing residual error frames includes performing a 4×4 inverse discrete transform.

5. The method of claim 1, wherein the producing motion compensated frames includes scaling down motion vectors by a predetermined factor to produce scaled motion vectors.

6. The method of claim 5, wherein motion compensation is performed based on the scaled motion vectors.

7. The method of claim 1, wherein the up-scaling is performed by a technique selected from a group consisting of repeating pixel values and linear interpolation.

8. The method of claim 1, wherein the up-scaling is performed in a horizontal direction.

9. The method of claim 1, wherein the up-scaling is performed in a same direction as down scaling in the residual error frames.

10. A memory medium including code for decoding a video bitstream at a first resolution, the code comprising:
a code for producing residual error frames at a second lower resolution;
a code for producing motion compensated frames at the second lower resolution;
a code for combining the residual error frames with the motion compensated frames to produce video frames; and
a code for up-scaling the video frames to the first resolution.

11. An apparatus for decoding a video bitstream at a first resolution, comprising:
means for producing residual error frames at a second lower resolution;
means for producing motion compensated frames at the second lower resolution;
means for combining the residual error frames with the motion compensated frames to produce video frames; and
means for up-scaling the video frames to the first resolution.

12. An apparatus for decoding a video bitstream at a first resolution, comprising:
a first path producing residual error frames at a second lower resolution;
a second path producing motion compensated frames at the second lower resolution;
an adder combining the residual error frames with the motion compensated frames to produce video frames; and
an up-scaler increasing the video frames from the second resolution to the first resolution.
